(19) United States
(12) Patent Application Publication
(10) Pub. No.: US 2025/0303645 A1
(43) Pub. Date: Oct. 2, 2025

(54) ULTRASONIC WELDMENT ASSEMBLY

(71) Applicant: IDEXX Laboratories Inc., Westbrook, ME (US)

(72) Inventor: Michael Schrameyer, Westbrook, ME (US)

(21) Appl. No.: 19/086,654

(22) Filed: Mar. 21, 2025

Related U.S. Application Data
(60) Provisional application No. 63/570,358, filed on Mar. 27, 2024.

(51) Int. Cl. B29C 65/00; B29C 65/08

(52) U.S. Cl. CPC B29C 66/30221; B29C 65/08

(57) ABSTRACT

An ultrasonic weldment assembly is provided which includes a first plastic member having a first contact surface, a second plastic member having a second contact surface, and a membrane positioned between the first and second plastic members. An energy director tongue extends outwardly from the first contact surface of the first plastic member towards the second contact surface, where the energy director tongue welds the first and second plastic members to one another. The first and second plastic members each include a membrane tensioning feature adjacent to the energy director tongue configured to tension the membrane. Methods for ultrasonically welding an assembly together are also provided.

### RELATED APPLICATION

This application claims priority to U.S. Provisional Application No. 63/570,358, filed on Mar. 27, 2024, the entire contents of which are incorporated by reference herein in its entirety.

### FIELD OF THE INVENTION

This disclosure relates to an ultrasonic weldment assembly which includes first and second plastic members with a membrane positioned between the first and second plastic members.

### BACKGROUND

Ultrasonic welding is a conventional fabrication technique used to permanently assemble plastic pieces together. A high-frequency ultrasonic mechanical vibration is transmitted by the ultrasonic welding machine to selectively melt/weld two plastic pieces together. The ultrasonic welding machine typically includes a horn and a nest. The ultrasonic high-frequency energy is generally directed into the horn. The nest is typically opposite the horn. One plastic piece may be positioned on the horn, and the other plastic piece may be positioned on the nest. The nest and/or horn may support and/or align the two pieces to be welded.

One of the plastic pieces generally includes an energy director, which may consist of a triangular bead of material on the surface to be welded. During the ultrasonic welding process, the two plastic pieces are brought into contact, and a weld joint is initiated at the energy director. The combination of applied force and surface friction increases the temperature until the melting point of the plastic is reached at the energy director. The ultrasonic energy is then removed and the weld between the two plastic pieces remains.

### SUMMARY

According to one aspect of the present disclosure, an ultrasonic weldment assembly is provided which includes a first plastic member having a first contact surface, a second plastic member having a second contact surface, and a membrane positioned between the first and second plastic members. The assembly also includes an energy director tongue extending outwardly from the first contact surface of the first plastic member towards the second contact surface, where the energy director tongue welds the first and second plastic members to one another, and the first and second plastic members each include a membrane tensioning feature adjacent to the energy director tongue configured to tension the membrane.

According to another aspect of the present disclosure, a method for ultrasonically welding an assembly together, the method including providing a first plastic member having a first contact surface, providing a second plastic member having a second contact surface, and positioning a membrane between the first and second plastic members. The method also includes tensioning the membrane with a membrane tensioning feature positioned on both of the first and second plastic members and cleaving the membrane with an energy director feature positioned on at least one of the first and second plastic members, where the tensioning step is performed before the cleaving step. The method further includes ultrasonically welding the first and second plastic members together at a weld joint with the membrane sandwiched between the first and second plastic members, where the cleaving step is performed before the ultrasonic welding step.

According to yet another aspect of the present invention, an ultrasonic weldment assembly is provided which includes a first plastic member having a first contact surface, a second plastic member having a second contact surface, and a membrane positioned between the first and second plastic members. The assembly also includes an energy director tongue extending outwardly from the first contact surface of the first plastic member towards the second contact surface, where the energy director tongue welds the first and second plastic members to one another. The first and second plastic members each include a membrane tensioning feature configured to tension the membrane, the membrane tensioning feature including a first tensioner groove extending inwardly from the first contact surface on the first plastic member, where the first tensioner groove is positioned adjacent a first side of the energy director tongue, and a second tensioner groove extending inwardly from the first contact surface on the first plastic member, wherein the second tensioner groove is positioned adjacent a second side of the energy director tongue. The membrane tensioning feature also includes a first tensioner rib extending outwardly from the second contact surface on the second plastic member, where the first tensioner rib is configured to align with the first tensioner groove on the first plastic member, and a second tensioner rib extending outwardly from the second contact surface on the second plastic member, where the second tensioner rib is configured to align with the second tensioner groove on the first plastic member, and where the energy director tongue is configured to cleave the membrane.

### BRIEF DESCRIPTION OF THE DRAWINGS

FIG. 1 is an exploded view of an ultrasonic weldment assembly, according to one or more embodiments;

FIG. 2A is a section view of a part of the ultrasonic weldment assembly of FIG. 1 prior to welding, according to one or more embodiments;

FIG. 2B is another section view of the part of the ultrasonic weldment assembly of FIG. 2A, according to one or more embodiments;

FIG. 2C is a section view of the part of an ultrasonic weldment assembly of FIG. 2A after welding, according to one or more embodiments;

FIG. 3 is a section view of the ultrasonic weldment assembly of FIG. 1, according to one or more embodiments;

FIG. 4 is a section view of the ultrasonic weldment assembly of FIG. 1 with a first plastic member spaced apart from a second plastic member, according to one or more embodiments;

FIG. 5 is a section view of the ultrasonic weldment assembly of FIG. 4 with the first plastic member moved toward the second plastic member, according to one or more embodiments;

FIG. 6 is a section view of the ultrasonic weldment assembly of FIG. 5 where an energy director tip initiates contact between the first and second plastic members, according to one or more embodiments;

FIG. 7 is a detailed view of the energy director tip initiating contact as shown in FIG. 6, according to one or more embodiments;

FIG. 8 is a side view of the ultrasonic weldment assembly of FIG. 6 after a weld joint is formed between the first and second plastic members, according to one or more embodiments;

FIG. 9 is a detailed view of the weld joint shown in FIG. 8, according to one or more embodiments;

FIG. 10A is a perspective view of a first plastic member of an ultrasonic weldment, assembly according to one or more embodiments;

FIG. 10B is an enlarged view of a portion of the ultrasonic weldment assembly shown in FIG. 10A, according to one or more embodiments;

FIG. 10C is a section view of an ultrasonic weldment assembly, according to one or more embodiments; and

FIG. 11 is a section view of an ultrasonic weldment assembly according to one or more embodiments.

### DETAILED DESCRIPTION

The present disclosure is directed to an ultrasonic weldment assembly. Applicant recognized that although ultrasonic welding is a conventional fabrication technique, that there may be problems when a membrane, such as a thin film membrane, is incorporated into the ultrasonic welding assembly. There are a variety of ultrasonic welding devices where a membrane is incorporated into the assembly, including, but not limited to filtration devices, microfluidic devices and/or cell culture flasks/single use bioreactor vessels.

Applicant recognized that the incorporation of a membrane into the ultrasonic weldment assembly often complicates the welding assembly process and may introduce additional manufacturing steps. For example, the membrane typically needs to be cut to shape before ultrasonic welding, and/or the membrane may need to be glued or otherwise fixed in place prior to the ultrasonic welding. Furthermore, specialized welding heads may be required to spot weld the membrane in place prior to ultrasonic welding. Finally, Applicant recognized that unconstrained membranes may bunch up during the ultrasonic welding process, which may render the finished weldment assembly unusable.

Therefore, aspects of the present disclosure are directed to a novel ultrasonic weldment assembly that can 1.) cut a membrane to shape, 2.) tension the membrane, and 3.) weld the assembly all within the conventional ultrasonic welding process. As set forth in more detail below, in one embodiment, these acts may all be done in substantially one step.

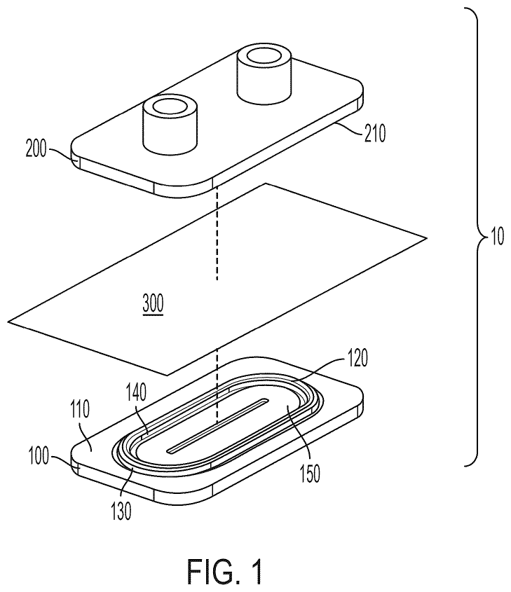

Turning now to the drawings, FIG. 1 illustrates an exploded assembly view of one ultrasonic weldment assembly 10 according to one embodiment. As set forth in more detail below, the assembly 10 includes a first plastic member 100 having a first contact surface 110 and a second plastic member 200 having a second contact surface 210, with a membrane 300 positioned between the first and second contact surfaces 110, 210. An energy director tip 120 extends outwardly from the first contact surface 110 of the first plastic member 100. As outlined in more detail below, the energy director tip 120 is configured to initiate a weld joint between the first and second plastic members 100, 200.

The present disclosure contemplates the use of a variety of types of materials for the first and second plastic members 100, 200, and the membrane 300. One of ordinary skill in the art will appreciate that a variety of types of plastic materials may be ultrasonically welded together, including, but not limited to thermoplastic materials, elastomers and/or thermoset resins. Exemplary thermoplastic materials include acrylonitrile butadiene styrene (ABS), polystyrene (PS), polypropylene (PP), polyethylene (PE), polyvinyl chloride (PVC), polymethyl methacrylate (PMMA), and/or polycarbonate (PC). In one particular embodiment, the first and second plastic members 100, 200 are made of crystalline polystyrene (PS) and the porous membrane 300 is made of polycarbonate (PC). In one embodiment, cyclic olefin copolymer (COC) is another material that may be used to form the ultrasonic weldment assembly.

As discussed in more detail below, unlike a conventional weldment assembly, the first and second plastic members 100, 200 each include a membrane tensioning feature adjacent to the energy director tip 120 which is configured to tension the membrane 300. For example, as shown in FIG. 1 and as described in more detail below, first plastic member 100 includes a first tensioner groove 130 and a second tensioner groove 140 adjacent the energy director tip 120. Furthermore, as outlined in more detail below, at least one of the first and second plastic members 100, 200 may also include a cleaving feature which is configured to cleave the membrane 300. In one embodiment, the energy director tip 120 is the cleaving member. However, it should be appreciated that in another embodiment, the cleaving member may be configured differently and may be a feature separate from the energy director tip 120, as the present disclosure is not so limited.

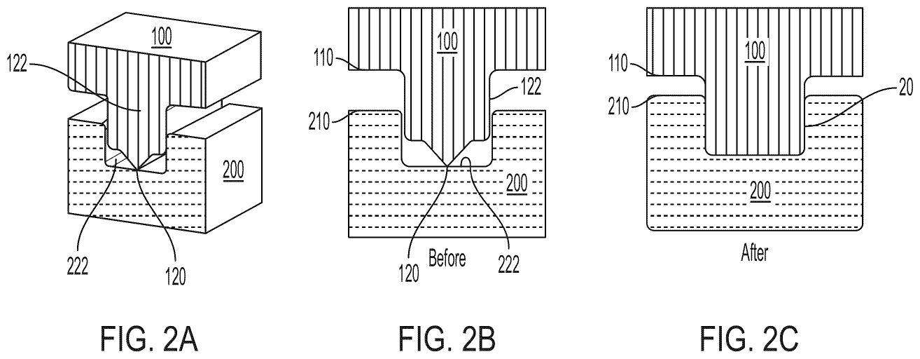

FIG. 2A-2C are schematic illustrations of an ultrasonic weldment assembly 10 according to one embodiment which illustrates a tongue and groove style ultrasonic welding energy director and weld bead design. As mentioned above, the energy director tip 120 extends outwardly from the first contact surface 110 of the first plastic member 100. As shown, an energy director tongue 122 extends outwardly from the first contact surface 110 of the first plastic member 100, and the energy director tip 120 is located on the energy director tongue 122. Furthermore, an energy director groove 222 extends inwardly from the second contact surface 210 of the second plastic member 200. As shown in FIGS. 2A-2C, the energy director groove 222 is configured to align with the energy director tongue 122 on the first plastic member 100. As shown the triangular shaped weld bead design of the energy director tip 120 may be substantially centered on the energy director tongue 122. FIGS. 2A and 2B illustrate a detailed view of the first and second plastic members 100, 200 just before the ultrasonic weld is formed. FIG. 2C illustrates the first and second plastic members 100, 200 after the weld joint 20 is formed. Before the weld joint 20 is formed, this area may also be called the weld formation site. As shown in FIG. 2C, after the weld is formed, the material forming the energy director tongue 122 fills the energy director groove 222 welding the first and second plastic members 100, 200 together.

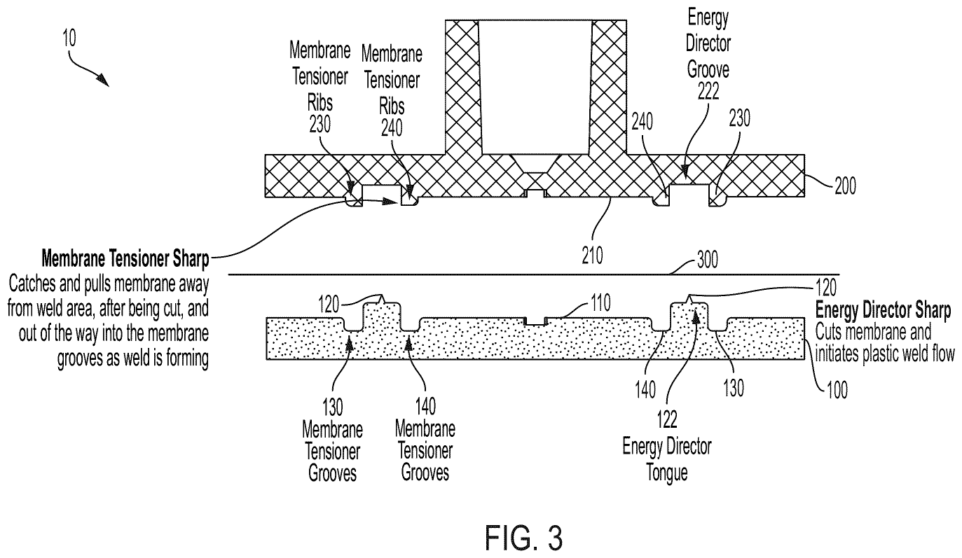

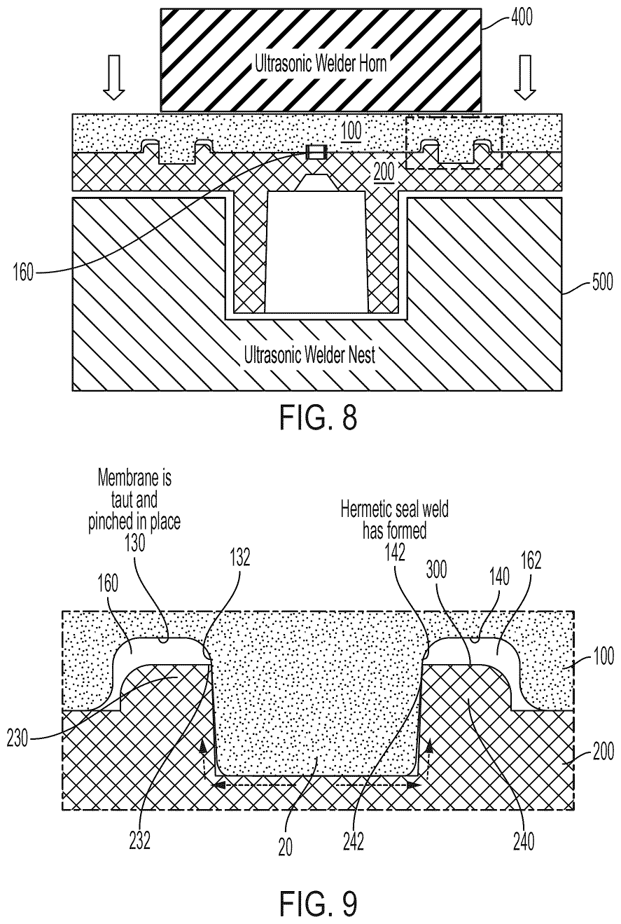

As shown in FIG. 1, in one embodiment, the energy director tip 120 (and energy director tongue 122 shown in FIG. 3) extends around a perimeter of an enclosed region 150 in the first plastic member 100 to form a hermetically sealed interior portion 160 (see FIG. 8) of the weldment. As shown in FIG. 1, the perimeter of the enclosed region may have a substantially elliptical shape. However, it should be appreciated that in embodiments, the energy director tip 120 (and energy director tongue 122) may be configured such that the perimeter of the enclosed region 150 has a substantially circular, rectangular, irregular shape, or any suitable shape as the disclosure is not so limited. It should be recognized that in one embodiment, where a hermetically sealed interior portion 160 is not necessary, the energy director tip 120, energy director tongue 122, and associated membrane tensioning features on the first and second plastic members 100, 200 may not extend a full 360° around the first and second plastic members 100, 200.

Applicant recognized that incorporating a membrane between two plastic members can create difficulties during the manufacturing process. In addition to the above-mentioned problems, in some circumstances, when using dissimilar materials, it is important to remove the membrane 300 from the weld formation site (i.e., weld joint 20) so that the membrane does not impede the weld formation. For example, if the membrane 300 has a higher melting temperature than the plastic member 100 and/or the plastic member 200, the existence of the membrane 300 in the weld joint 20 may impede the plate weld flow. Accordingly, as set forth in more detail below, aspects of the present disclosure are directed to an ultrasonic weldment assembly which includes membrane tensioning features that are configured to tension the membrane 300 such that the membrane 300 is not positioned in the weld joint 20.

Turning now to FIG. 3, one embodiment of an ultrasonic weldment assembly 10 with the membrane tensioning features on the first and second plastic members 100, 200 will now be more fully described. In this embodiment, the energy director tip 120 extends outwardly from a first contact surface 110 on the first plastic member 100, and as discussed in more detail below, the energy director tip 120 is configured to initiate a weld joint between the first and second plastic members 100, 200. As mentioned above, in embodiments, the energy director tip 120 extends around a perimeter of an enclosed region in the first plastic member 100, thus in the section view shown in FIG. 3, two energy director tips 120 are illustrated, one on the left side of the weldment assembly 10 and one on the right side of the weldment assembly 10. It should be recognized that in one embodiment where the energy director tip extends around a 3600 perimeter, this is one continuous energy director tip 120 (as shown in FIG. 1).

As shown in FIG. 3, the membrane tensioning feature on the first plastic member 100 includes a first tensioner groove 130 extending inwardly from the first contact surface 110. As shown, in one embodiment, first tensioner groove 130 is adjacent a first side of the energy director tip 120. In this embodiment, the membrane tensioning feature on the first plastic member 100 also includes a second tensioner groove 140 extending inwardly from the first contact surface 110 on the first plastic member 100, and as shown, the second tensioner groove 140 is positioned adjacent a second side of the energy director tip 120.

Furthermore, as shown in FIG. 3, in one embodiment, the membrane tensioning feature on the second plastic member 200 includes a first tensioner rib 230 extending outwardly from the second contact surface 210 on the second plastic member 200, and the first tensioner rib is configured to align with the first tensioner groove 130 on the first plastic member 100. In this embodiment, the membrane tensioning feature on the second plastic member 200 also includes a second tensioner rib 240 extending outwardly from the second contact surface 210, and the second tensioner rib 240 is configured to align with the second tensioner groove 140 on the first plastic member 100.

As set forth in more detail below, the tensioner grooves 130, 140 and the tensioner ribs 230, 240 are configured to tension the membrane 300. In one embodiment, the energy director tip 120 is configured to first cleave the membrane 300 and thereafter the energy director tip 120 initiates the plastic weld flow. In one embodiment, the tensioner ribs 230, 240 may be configured to catch and pull the membrane 300 away from the weld joint 20 after the membrane 300 is cut, and out of the way into the tensioner grooves 130, 132 as the weld is forming.

As mentioned above, in one embodiment shown in FIG. 1, the energy director tip 120 extends around a perimeter of an enclosed region 150 in the first plastic member 100, and may, for example, extend in a substantially elliptical shape. In one embodiment, the membrane tensioning feature on the first plastic member 100 may also extend around a perimeter of an enclosed region 150 (FIG. 1) of the first plastic member 100. Furthermore, in one embodiment, the membrane tensioning feature on the second plastic member 200 may also extend around a perimeter of the enclosed region 150 (FIG. 1) in the second plastic member 200. For example, in one embodiment, the membrane tensioning feature on the first plastic member may include at least one tensioner groove 130 which may extend around the enclosed region 150 having a shape substantially mirroring the substantially elliptical shape of the energy director tip 120. Furthermore, in one illustrative embodiment, the membrane tensioning feature on the first plastic member 100 includes both a first tensioner groove 130 and a second tensioner groove 140, which each substantially mirrors the shape/perimeter of the energy director tip 120, where the first tensioner groove 130 is positioned on a first side of the energy director tip just outside of the enclosed region 150, and the second tensioner groove 140 is positioned on a second side of the energy director tip 120 just inside of the enclosed region 150.

Although FIG. 3 illustrates tensioner grooves 130, 140 on the same plastic member 100 as the energy director tip 120 and the energy director tongue 122, and tensioner ribs 230, 240 on the same plastic member 200 as the energy director groove 222, the present disclosure also contemplates different configurations for the membrane tensioning features on the first and second plastic members 100, 200. For example, in another embodiment, the membrane tensioning feature on the first member 100 may include one or more tensioner ribs 230, 240 which may be adjacent the energy director tip 120 and energy director tongue 122.

Furthermore, in one embodiment, the membrane tensioning feature on the second member 200 may include one or more tensioner grooves 130, 140 which may, for example, be adjacent the energy director groove 222. In one illustrative embodiment, the first tensioner rib 230 is positioned adjacent a first side of the energy director groove 222, and the second tensioner rib 240 is positioned adjacent a second side of the energy director groove 222. One of ordinary skill in the art will appreciate that in one embodiment, the size, shape, and location of these tensioning features may be modified to optimize the membrane tensioning properties in a particular application.

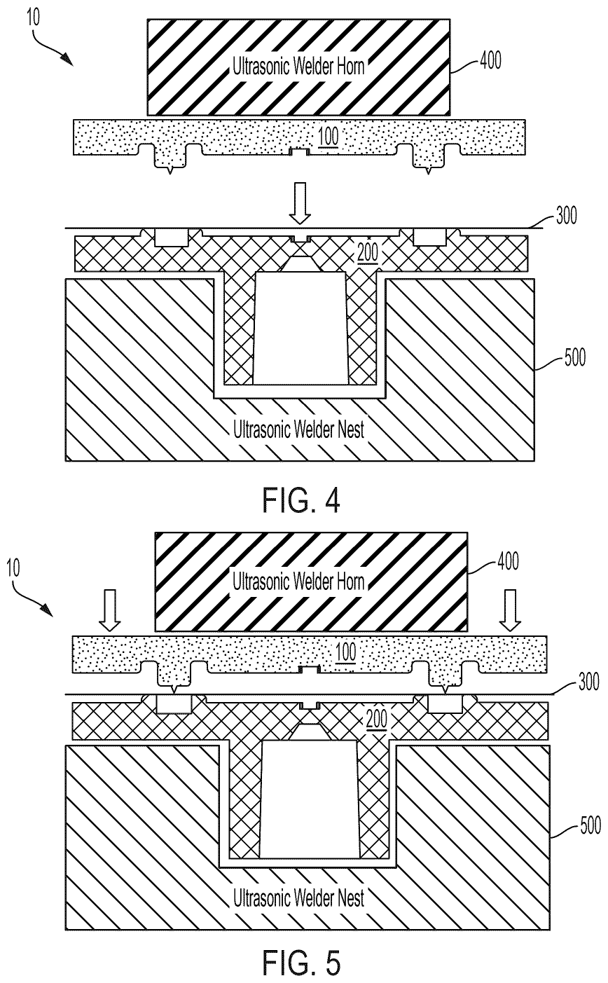

FIGS. 4-9 illustrate one embodiment of the ultrasonic welding process in greater detail. FIG. 4 illustrates step one where the ultrasonic weldment assembly 10 includes the first plastic member 100 spaced apart from the second plastic member 200. In this embodiment, the first plastic member 100 is engaged with an ultrasonic welder horn 400, and the second plastic member 200 is engaged with an ultrasonic welder nest 500. In one embodiment, the membrane 300 sheet is draped over the second plastic member 200, and as shown in FIG. 4, the tensioner ribs 230, 240 contact the membrane 300. Applicant recognized that the tensioner ribs 230, 240 may position the membrane 300 and keep the membrane taut on the second plastic member 200.

FIG. 5 illustrates step two, where the ultrasonic weldment assembly 10 with a first plastic member 100 moved toward the second plastic member 200. In one embodiment, the ultrasonic welder horn 400 is lowered down towards the ultrasonic welder nest 500 until the energy director tip 120 approaches the membrane 300, then ultrasonic vibration may be activated. It should be appreciated that in another embodiment, the second plastic member 200 and ultrasonic welder nest 500 is moved towards the first plastic member 100 as the present disclosure is not so limited.

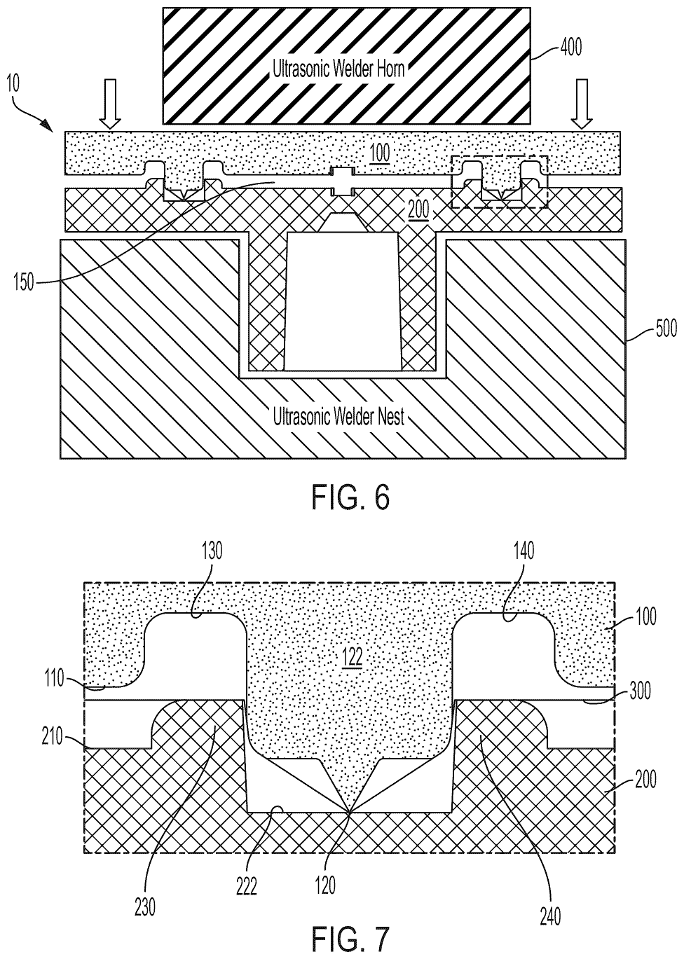

FIGS. 6 and 7 illustrate step three, where first the energy director tongue 122 and energy director tip 120 pulls the membrane 300 into the energy director groove 222, and then pinches the membrane 300 against the bottom surface of the energy director groove 222 and cuts/cleaves the membrane 300 just prior to weld flow initiating.

FIGS. 8 and 9 illustrate step four, where due to the vibrational friction concentrated on the energy director tip 120 against the bottom surface of the energy director groove 222 (FIG. 7), the plastic tip 120 begins to heat, which causes the plastic material to flow. As shown, the membrane 300 gets pulled out of the weld site/weld joint 20 as this heated interface propagates up the energy director tongue 122 (FIG. 7), and the energy director tongue 122 sinks into the energy director groove 222 (FIG. 7). As shown, the membrane 300 gets pinched in place between the first and second plastic members 100, 200 when the weld is finished.

As shown in FIGS. 8 and 9, the membrane tensioning features on the first and second plastic members 100, 200 are configured to tension the membrane 300 such that after the membrane 300 is cleaved, the membrane 300 is not positioned in the weld joint 20. More specifically, as shown by the arrows in FIG. 9, after the membrane 300 is cleaved by the energy director tip 120, the membrane 300 is pulled away from the weld joint 20 due to the membrane tensioning features on the first and second members 100, 200. For example, it should be recognized that the tensioner rib 230 and tensioner groove 130 may be configured on the left side of the energy director tip 120 to pull the membrane away from the energy director tip 120, away from the bottom surface of the energy director groove 222 and at least partially up the substantially vertical side wall of the tensioner rib 230, towards the top surface of the tensioner rib 230. As shown, in one embodiment, the tensioner rib 230 includes an angled corner 232 separating its vertical sidewall from its top surface and the angled corner 232 is configured to engage with tensioner groove surface 132 to tension the left side of the membrane 300. It should be recognized that this portion of the membrane may be pulled into/towards a hermetically sealed interior portion 160 of the weldment. Conversely, as shown on the right side of FIG. 9, it should be recognized that the tensioner rib 240 and tensioner groove 140 may be configured on the right side of the energy director tip 120 to pull the membrane away from the energy director tip 120, away from the bottom surface of the energy director groove 222 and at least partially up the substantially vertical side wall of the tensioner rib 240, towards the top surface of the tensioner rib 240. As shown, in one embodiment, the tensioner rib 240 includes an angled corner 242 that is configured to engage with tensioner groove surface 142 to tension the left side of the membrane 300. It should be recognized that this portion of the membrane 300 may be the cleaved/cut portion of the membrane 300 (i.e., excess membrane 300) which may not form the finished ultrasonic weldment assembly 10. In this respect, the membrane tension features on a first side of the energy director tip 120 may pull the membrane 300 out of one side of the weld joint 20, whereas the membrane tension features on a second side of the energy director tip 120 may pull the membrane 300 out of the second side of the weld joint. In one embodiment, the ultrasonic weldment assembly 10 may only include membrane tensioning features on one side of the weld joint 20, whereas in another embodiment, the ultrasonic weldment assembly 10 may include membrane tensioning features on both sides of the weld joint 20. For example, in one embodiment, the ultrasonic weldment assembly 10 may only include membrane tensioning features on the interior portion 160 of the weldment. And in another embodiment, the ultrasonic weldment assembly 10 may only include membrane tensioning features on an exterior portion 162 of the weldment.

The specific shapes of the membrane tensioning features may vary according to different embodiments of the present disclosure. In the embodiment illustrated in FIGS. 3-9, the membrane tensioning features include a tensioner grooves 130, 140 having substantially rounded edges/corners. Furthermore, as shown in FIGS. 3-4, in one embodiment, the membrane tensioning features may also include tensioner ribs 230, 240 which may each include an angled/sharp corner 232, 242 formed on each side of the energy director groove 222, with a rounded corner on the outer portion adjacent the second contact surface 210. One of ordinary skill in the art will recognize that the shape and size of the mating membrane tensioning features on the first and second members 100, 200 may be selected to provide desirable tensioning of the membrane 300 during the ultrasonic welding process.

As mentioned above and as shown in FIG. 1, in one embodiment, the membrane tensioning features on the first and second members 100, 200 may extend around a perimeter of an enclosed region 150. In one embodiment, the size and shape of the membrane tensioning features may be substantially uniform along that perimeter. In another embodiment, the size and/or shape of the first tensioner rib 230 may not be substantially uniform along the perimeter, and may for example, includes at least three sharp corners spaced apart along the second plastic member 200 to provide a plurality of contact points to tension the membrane 300 on the second plastic member 200. It should be appreciated that a minimum of three contact points may be desired to tension the membrane 300 on the first tensioner rib 230, but that in other embodiments, the tensioner rib 230 may include more than three contact points to tension the membrane as the present disclosure is not so limited.

Furthermore, as illustrated, in one embodiment, the first and second plastic members 100, 200 are configured as plate-like members. However, the present disclosure also contemplates other non-plate-like configurations as the disclosure is not limited in this respect. Additionally, as shown, the first contact surface 110 of the first plastic member 100 is a substantially planar surface, the second contact surface 210 of the second plastic member 200 is a substantially planar surface, and the first and second contact surfaces 110, 210 are substantially parallel with each other. It should be recognized that these shapes and configuration may be desirable and/or conventional for an ultrasonic weldment assembly 10 configured to be used as a microfluidic device and/or as a filtration module.

In one embodiment, the thickness of the first and second plastic members may range from 1 mm-100 mm and the thickness of the membrane 300 may range from 0.1 mm to 1 mm.

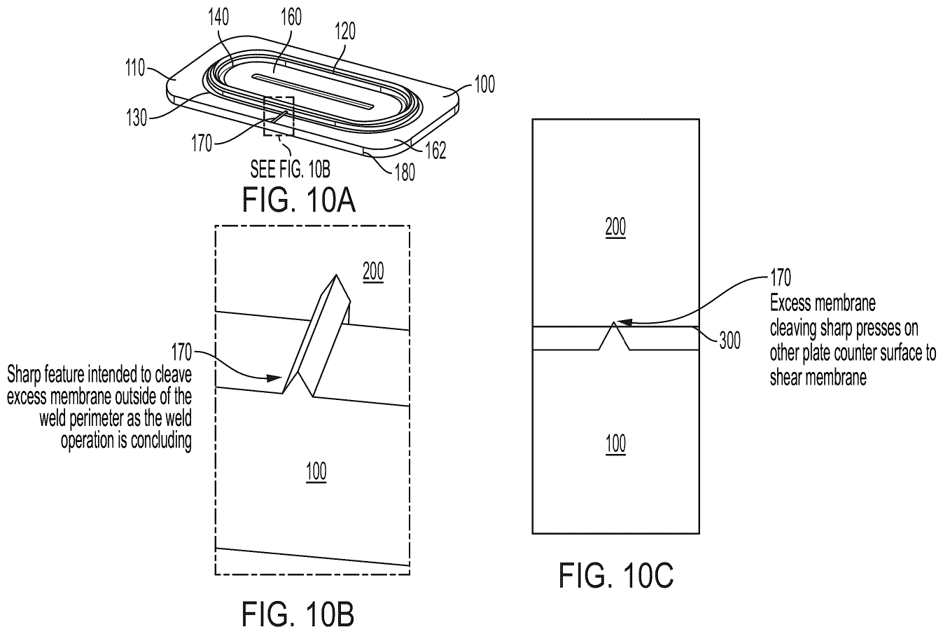

Turning now to FIGS. 10A-10C, another embodiment of an ultrasonic weldment assembly will now be described. As shown in FIG. 10A, the first plastic member 100 includes an energy director tip 120 extending outwardly from the first contact surface 110 configured to initiate a weld joint between the first and second plastic members. As discussed above, the first plastic member 100 has a first tensioning groove 130 positioned on a first side of the energy director tip 120 and a second tensioning groove 140 positioned on a second side of the energy director tip 120. The weldment assembly has an interior portion 160 defined as the portion inside of the energy director tip 120, and an exterior portion 162 defined as the portion outside of the energy director tip 120. As discussed above, in one embodiment, the energy director tip 120 is configured to cleave the membrane 300. Unlike the above-described embodiments, as shown in FIGS. 10A-10C, in one embodiment, the weldment assembly further includes a second cleaving feature 170 which may extend from the membrane tensioning feature 130 outwardly to an outer perimeter 180 of the first plastic member 100. The second cleaving feature 170 is configured to cleave the excess membrane in the exterior portion 162 of the weldment to make the excess membrane material easier to remove from the weldment assembly. FIG. 10A illustrates a perspective view of the first plastic member 100 which includes this second cleaving feature 170, and FIGS. 10B and 10C illustrate the first plastic member 100 with the second cleaving feature 170 coupled to the second plastic member 200. As shown, the second cleaving feature 170 presses against the second plastic member 200 to shear the excess membrane 300. As shown, the second cleaving feature 170 is a sharp feature intended to cleave excess membrane 300 outside of the weld perimeter as the weld operation is concluding. As shown, in one embodiment, the second cleaving feature 170 includes a substantially uniform tip that extends outwardly to the outer perimeter 180 of the first plastic member 100.

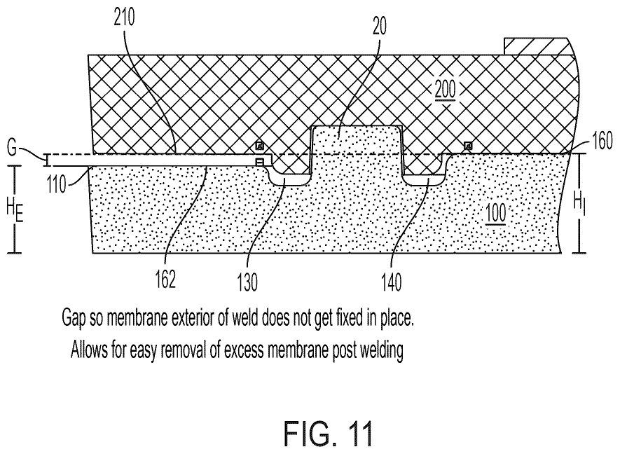

FIG. 11 is a side partial view of an ultrasonic weldment assembly according to yet another embodiment. In this embodiment, the first and second plastic members 100, 200 are designed to make it easier to remove the cleaved excess membrane 300 after the ultrasonic welding. As shown, after the weld joint 20 is formed, there may be a small gap between the first and second plastic members 100, 200 so that the excess portion of the membrane 300 in the exterior portion 162 of the weldment does not get fixed/welded in place. This may allow for easy removal of the excess membrane post ultrasonic welding. As shown, in one embodiment, the first plastic member 100 has an interior portion 160 defined as the portion inside of the energy director tip 120 and having an interior portion height, H_{I} and an exterior portion 162 defined as the portion outside of the energy director tip 120 and having an exterior portion height H_{E}, where the exterior portion height H_{E} is less than the interior portion height H_{I} to provide a plate gap G between the first and second contact surfaces 110, 210 to remove the cleaved excess membrane 300. In one embodiment, the plate gap G between the first and second contact surfaces 110, 210 is about 0.25 mm, but in another embodiment, it should be recognized that the plate gap G may range from about 0.1 mm to 0.5 mm, and in yet another embodiment, may range from 1 mm-5 mm. In one embodiment, the plate gap G is at least 0.1 mm thicker than the uncompressed thickness of the membrane 300.

As set forth above, the present disclosure is directed to novel techniques for tensioning a membrane between two plastic members of a weldment assembly during the ultrasonic welding process. In one embodiment, the melting point of the first plastic member 100 is substantially the same as the melting point of the second plastic member 200 such that the two plastic members begin to form the weld joint at substantially the same temperature and/or time. In one embodiment, the first and second plastic members 100, 200 may be made of the same, or substantially the same material.

As mentioned above, aspects of the present disclosure are directed to membrane tensioning features on both the first and second members 100, 200. In one embodiment, the tensioning features are configured to tension the membrane 300 such that after the membrane is cleaved, the membrane is not positioned in the weld joint 20. This feature may be beneficial when the melting point of the membrane 300 is substantially different than the melting points of the first and second plastic members 100, 200. In other words, it may be desirable to tension the membrane 300 so that the membrane does not interfere with the weld flow between the first and second plastic members 100, 200.

The present disclosure also contemplates various methods for ultrasonically welding an assembly. For example, in one embodiment, a method for ultrasonically welding an assembly together includes providing a first plastic member 100 having a first contact surface 110, providing a second plastic member 200 having a second contact surface 210, and positioning a membrane 300 between the first and second plastic members 100, 200. The method also includes tensioning the membrane with a membrane tensioning feature positioned on both of the first and second plastic members, and cleaving the membrane with an energy director feature positioned on at least one of the first and second plastic members, where the tensioning step is performed before the cleaving step. The method may further include ultrasonically welding the first and second plastic members together at a weld joint 20 with the membrane sandwiched between the first and second plastic members, where the cleaving step is performed before the ultrasonic welding step. In one embodiment, the tensioning step is configured to tension the membrane such that after the membrane is cleaved, the membrane is not positioned in the weld joint 20.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. An ultrasonic weldment assembly comprising:
a first plastic member having a first contact surface;
a second plastic member having a second contact surface;
a membrane positioned between the first and second plastic members;
an energy director tongue extending outwardly from the first contact surface of the first plastic member towards the second contact surface, wherein the energy director tongue welds the first and second plastic members to one another; and
wherein the first and second plastic members each include a membrane tensioning feature adjacent to the energy director tongue configured to tension the membrane.

2. The ultrasonic weldment assembly of claim 1, wherein at least one of the first and second plastic members includes a cleaving feature configured to cleave the membrane.

3. The ultrasonic weldment assembly of claim 1, wherein the energy director tongue welds the first and second plastic members together at a weld joint, and wherein the membrane tensioning features on the first and second plastic members are configured to tension the membrane such that after the membrane is cleaved, the membrane is not positioned in the weld joint.

4. The ultrasonic weldment assembly of claim 1, wherein the membrane tensioning feature on the first plastic member comprises a first tensioner groove extending inwardly from the first contact surface on the first plastic member, wherein the first tensioner groove is positioned adjacent a first side of the energy director tongue; and
wherein the membrane tensioning feature on the second plastic member comprises a first tensioner rib extending outwardly from the second contact surface on the second plastic member, wherein the first tensioner rib is configured to align with the first tensioner groove on the first plastic member.

5. The ultrasonic weldment assembly of claim 4, wherein the membrane tensioning feature on the first plastic member further comprises a second tensioner groove extending inwardly from the first contact surface on the first plastic member, wherein the second tensioner groove is positioned adjacent a second side of the energy director tongue; and
wherein the membrane tensioning feature on the second plastic member further comprises a second tensioner rib extending outwardly from the second contact surface on the second plastic member, wherein the second tensioner rib is configured to align with the second tensioner groove on the first plastic member.

6. The ultrasonic weldment assembly of claim 5, wherein the energy director tongue is configured as a tongue and groove style energy director, the weldment assembly further comprising:
an energy director tip extending outwardly from the first contact surface of the first plastic member, wherein the energy director tip is located on the energy director tongue; and
an energy director groove extending inwardly from the second contact surface of the second plastic member, wherein the energy director groove is configured to align with the energy director tongue on the first plastic member.

7. The ultrasonic weldment assembly of claim 6, wherein the first tensioner rib is positioned adjacent a first side of the energy director groove, and wherein the second tensioner rib is positioned adjacent a second side of the energy director groove.

8. The ultrasonic weldment assembly of claim 1, wherein the energy director tongue extends around a perimeter of an enclosed region in the first plastic member to form a hermetically sealed interior portion of the weldment.

9. The ultrasonic weldment assembly of claim 1, wherein the membrane tensioning feature on the first plastic member extends around a perimeter of an enclosed region in the first plastic member, and wherein the membrane tensioning feature on the second plastic member extends around a perimeter of an enclosed region the second plastic member.

10. The ultrasonic weldment assembly of claim 4, wherein the first tensioner rib includes at least three sharp corners spaced apart along the second plastic member to provide a plurality of contact points to tension the membrane on the second plastic member.

11. The ultrasonic weldment assembly of claim 1, wherein the first contact surface of the first plastic member is a substantially planar surface, the second contact surface of the second plastic member is a substantially planar surface, and the first and second contact surface are substantially parallel with each other.

12. The ultrasonic weldment assembly of claim 1, wherein the first plastic member has an interior portion defined as the portion inside of the energy director tongue and having an interior portion height, and an exterior portion defined as the portion outside of the energy director tongue and having an exterior portion height, wherein the exterior portion height is less than the interior portion height to provide a gap between the first and second contact surfaces to remove the cleaved excess membrane.

13. The ultrasonic weldment assembly of claim 1, wherein the weldment assembly has an interior portion defined as the portion inside of the energy director tongue, and an exterior portion defined as the portion outside of the energy director tongue, and
wherein the weldment assembly further comprises a second cleaving feature extending from the membrane tensioning feature outwardly to an outer perimeter of the first plastic member, and configured to cleave the excess membrane in the exterior portion of the weldment.

14. The ultrasonic weldment of claim 1, wherein the melting point of the first plastic member is substantially the same as the melting point of the second plastic member.

15. The ultrasonic weldment of claim 14, wherein the melting point of the membrane is substantially different than the melting points of the first and second plastic members.

16. The ultrasonic weldment of claim 1, wherein the first and second plastic members are configured as plate-like members.

17. A method for ultrasonically welding an assembly together, the method comprising:
providing a first plastic member having a first contact surface;
providing a second plastic member having a second contact surface;
positioning a membrane between the first and second plastic members;
tensioning the membrane with a membrane tensioning feature positioned on both of the first and second plastic members;
cleaving the membrane with an energy director feature positioned on at least one of the first and second plastic members, wherein the tensioning step is performed before the cleaving step; and
ultrasonically welding the first and second plastic members together at a weld joint with the membrane sandwiched between the first and second plastic members, and wherein the cleaving step is performed before the ultrasonic welding step.

18. The method of claim 17, wherein the tensioning step is configured to tension the membrane such that after the membrane is cleaved, the membrane is not positioned in the weld joint.

19. An ultrasonic weldment assembly comprising:
a first plastic member having a first contact surface;
a second plastic member having a second contact surface;
a membrane positioned between the first and second plastic members;
an energy director tongue extending outwardly from the first contact surface of the first plastic member towards the second contact surface, wherein the energy director tongue welds the first and second plastic members to one another;
wherein the first and second plastic members each include a membrane tensioning feature configured to tension the membrane; the membrane tensioning feature comprising:
a first tensioner groove extending inwardly from the first contact surface on the first plastic member, wherein the first tensioner groove is positioned adjacent a first side of the energy director tongue;
a second tensioner groove extending inwardly from the first contact surface on the first plastic member, wherein the second tensioner groove is positioned adjacent a second side of the energy director tongue;
a first tensioner rib extending outwardly from the second contact surface on the second plastic member, wherein the first tensioner rib is configured to align with the first tensioner groove on the first plastic member;
a second tensioner rib extending outwardly from the second contact surface on the second plastic member, wherein the second tensioner rib is configured to align with the second tensioner groove on the first plastic member; and
wherein the energy director tongue is configured to cleave the membrane.
